(19) United States
(12) Patent Application Publication
(10) Pub. No.: US 2022/0253519 A1
(43) Pub. Date: Aug. 11, 2022

(54) FACE AUTHENTICATION SYSTEM AND ELECTRONIC APPARATUS

(71) Applicant: SONY SEMICONDUCTOR SOLUTIONS CORPORATION, KANAGAWA (JP)

(72) Inventor: HAYATO WAKABAYASHI, KANAGAWA (JP)

(21) Appl. No.: 17/754,375

(22) PCT Filed: Jul. 20, 2020
(86) PCT No.: PCT/JP2020/027985

§ 371 Date: Mar. 31, 2022

(30) Foreign Application Priority Data
Oct. 9, 2019 (JP) 2019-185817

(51) Int. Cl. G06F 21/32; G06V 40/16; G06V 10/141; G06V 10/20; G06V 10/60; G06V 10/74; G06T 7/521

(52) U.S. Cl. CPC G06F 21/32; G06V 40/172; G06V 10/141; G06V 10/255; G06V 10/60; G06T 2207/30201; G06T 7/521; G06T 2207/10028; G06T 2207/10048; G06T 2207/10152; G06V 10/761

(57) ABSTRACT

A face authentication system of the present disclosure includes: a surface-emitting light source that irradiates a subject with light, and enables control of light emission/non-light emission in pixel units; an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and a signal processor that performs authentication of a face that is the subject on the basis of a detection result of the event detection sensor and the pixel signal generated by the pixel signal generator. In addition, an electronic apparatus of the present disclosure includes a face authentication system having a configuration described above.

### TECHNICAL FIELD

The present disclosure relates to a face authentication system and an electronic apparatus.

### BACKGROUND ART

A technology of a structured light scheme that uses a dynamic projector and a dynamic vision camera has been proposed as a system for acquiring a three-dimensional (3D) image (information about a depth of a surface of an object/depth information) and measuring a distance to a subject (see PTL 1, for example).

In the structured light scheme, light having a predetermined pattern is projected onto a measurement target/subject from the dynamic projector and depth information/distance information is acquired by analyzing a degree of distortion of the pattern on the basis of a result of imaging by the dynamic vision camera.

### CITATION LIST

### Patent Literature

PTL 1: US 2019/0045173 A1

### SUMMARY OF THE INVENTION

### Problem to be Solved by the Invention

A technology using a technology of a structured light scheme is usable in a distance measurement system for measuring a distance to a subject and a three-dimensional image acquiring system that acquires a three-dimensional (3D) image; however, it is only possible to acquire a three-dimensional shape.

Therefore, an object of the present disclosure is to provide a face authentication system that makes it possible not only to acquire a three-dimensional shape but also to perform face authentication, and an electronic apparatus including the face authentication system.

### Means for Solving the Problem

A face authentication system of the present disclosure to achieve the above-described object includes:

a surface-emitting light source that irradiates a subject with light, and enables control of light emission/non-light emission in pixel units;

an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and

a signal processor that performs authentication of a face that is the subject on the basis of a detection result of the event detection sensor and the pixel signal generated by the pixel signal generator.

Furthermore, an electronic apparatus of the present disclosure to achieve the above-described object includes a face authentication system having the above-described configuration.

### BRIEF DESCRIPTION OF THE DRAWINGS

FIG. 1A is a schematic diagram illustrating an example of a configuration of a face authentication system according to a first embodiment of the present disclosure, and FIG. 1B is a block diagram illustrating an example of a circuit configuration.

FIG. 2A is a diagram illustrating an array dot arrangement of light sources of a vertical cavity surface emitting laser in the face authentication system according to the first embodiment of the present disclosure, and FIG. 2B is a diagram illustrating a random dot arrangement in contrast to the array dot arrangement.

FIG. 3 is a block diagram illustrating an example of a configuration of an event detection sensor in the face authentication system according to the first embodiment.

FIG. 4 is a circuit diagram illustrating an example of a circuit configuration of a pixel signal generator in a pixel.

FIG. 5 is a circuit diagram illustrating a circuit configuration example 1 of the event detector in the pixel.

FIG. 6 is a circuit diagram illustrating a circuit configuration example 2 of the event detector in the pixel.

FIG. 7A is a perspective view of an outline of a chip structure of the vertical cavity surface emitting laser, and FIG. 7B is a perspective view of an outline of a chip structure of the event detection sensor.

FIG. 8 is flowchart illustrating an example of a face authentication process in the face authentication system according to the first embodiment.

FIG. 9A is a schematic diagram illustrating a light emission region upon object detection on the chip structure of the vertical cavity surface emitting laser, and FIG. 9B is a schematic diagram illustrating a light reception region upon object detection on the chip structure of the event detection sensor.

FIG. 10A is a schematic diagram illustrating a light emission region upon face authentication on the chip structure of the vertical cavity surface emitting laser, and FIG. 10B is a schematic diagram illustrating a ROI region upon face authentication on the chip structure of the event detection sensor.

FIG. 11 is a block diagram illustrating the ROI region upon face authentication in a pixel array section of the event detection sensor.

FIG. 12A is a schematic diagram illustrating an example of a configuration of a face authentication system according to a second embodiment of the present disclosure, and FIG. 12B is a flowchart illustrating a face authentication process example in the face authentication system according to the second embodiment.

FIG. 13 is an external view of a smartphone as a specific example of an electronic apparatus of the present disclosure as viewed from front side, where FIG. 13A is an example of a smartphone including the face authentication system according to the first embodiment, and FIG. 13B is an example of a smartphone including the face authentication system according to the second embodiment.

### MODES FOR CARRYING OUT THE INVENTION

Hereinafter, modes for carrying out the technology of the present disclosure (hereinafter referred to as “embodiments”) are described in detail with reference to the drawings. The technology of the present disclosure is not limited to the embodiments. In the following description, the same components, or components having the same function are denoted by the same reference signs, and redundant description is omitted. It is to be noted that description is given in the following order.

### 1. Overall Description of Face Authentication System and Electronic Apparatus of Present Disclosure

### 2. Face Authentication System According to First Embodiment

2-1. System Configuration Example

2-2. Vertical Cavity Surface Emitting Laser (VCSEL)

2-3. Event Detection Sensor (DVS)
2-3-1. Configuration Example of Event Detection Sensor
2-3-2. Circuit Configuration Example of Pixel
   2-3-2-1. Pixel Signal Generator
   2-3-2-2. Circuit Configuration Example 1 of Event Detector
   2-3-2-3. Circuit Configuration Example 2 of Event Detector

2-4. Chip Structure
2-4-1. Chip Structure of Vertical Cavity Surface Emitting Laser
2-4-2. Chip Structure of Event Detection Sensor

2-5. Face Authentication Process Example

2-6. Modification Examples of First Embodiment

### 3. Face Authentication System According to Second Embodiment

3-1. System Configuration Example

3-2. Face Authentication Process Example

### 4. Modification Examples

5. Electronic Apparatus of Present Disclosure (An example of a smartphone)

### 6. Possible Configurations of Present Disclosure

### Overall Description of Face Authentication System and Electronic Apparatus of Present Disclosure

In a face authentication system and an electronic apparatus of the present disclosure, a surface-emitting light source may be configured to include a surface-emitting semiconductor laser. In addition, the surface-emitting semiconductor laser preferably includes a vertical cavity surface emitting laser, and the vertical cavity surface emitting laser may be configured to enable dot irradiation in pixel units, or line irradiation in pixel column units.

In the face authentication system and the electronic apparatus of the present disclosure including the preferred configurations described above, an event detection sensor may be configured to have infrared sensitivity. In addition, the surface-emitting light source and the event detection sensor may be configurated to be operable only in a specific region of a pixel array.

In addition, in the face authentication system and the electronic apparatus of the present disclosure including the preferred configurations described above, a signal processor may be configured to determine a distance to a subject with use of a detection result of the event detection sensor. In addition, the signal processor may be configured to acquire a gray scale from a pixel signal generated by the pixel signal generator.

In addition, in the face authentication system and the electronic apparatus of the present disclosure including the preferred configurations described above, the signal processor may be configured to perform object detection at a specific position and object shape recognition on the basis of a detection result of the event detection sensor and a pixel signal generated by the pixel signal generator. Furthermore, the signal processor may be configured to perform object feature recognition on the basis of a detection result of the event detection sensor and a pixel signal generated by the pixel signal generator.

Another face authentication system of the present disclosure includes an event detection sensor that includes an event detector that detects, as an event, that a change in luminance of a pixel that photoelectrically converts entering light from a subject exceeds a predetermined threshold, and a pixel signal generator that generates a pixel signal of a gray-scale voltage generated by photoelectric conversion; and a signal processor that performs authentication of a face as the subject on the basis of a detection result of the event detector and the pixel signal generated by the pixel signal generator.

### Face Authentication System According to First Embodiment

A face authentication system according to a first embodiment of the present disclosure includes a combination of a surface-emitting light source that enables control of light emission/non-light emission in pixel units, and an event detection sensor that detects an event, and uses a technology of a structured light scheme. Furthermore, the face authentication system according to the first embodiment has a function of acquiring a three-dimensional (3D) image (distance measurement function), and a function of recognizing a face on the basis of gray-scale information (authentication function). In the structured light scheme, coordinates of a point image and from which light source (point light source) the point image has been projected are identified by pattern matching to thereby perform distance measurement.

The face authentication system according to the first embodiment has the function of acquiring a three-dimensional image, and may be therefore referred to as a three-dimensional image acquiring system. In addition, the face authentication system according to the first embodiment is able not only to recognize a face but also to widely recognize an object (living body) on the basis of gray-scale information, and may be therefore referred to as an object recognition (object authentication) system.

### System Configuration Example

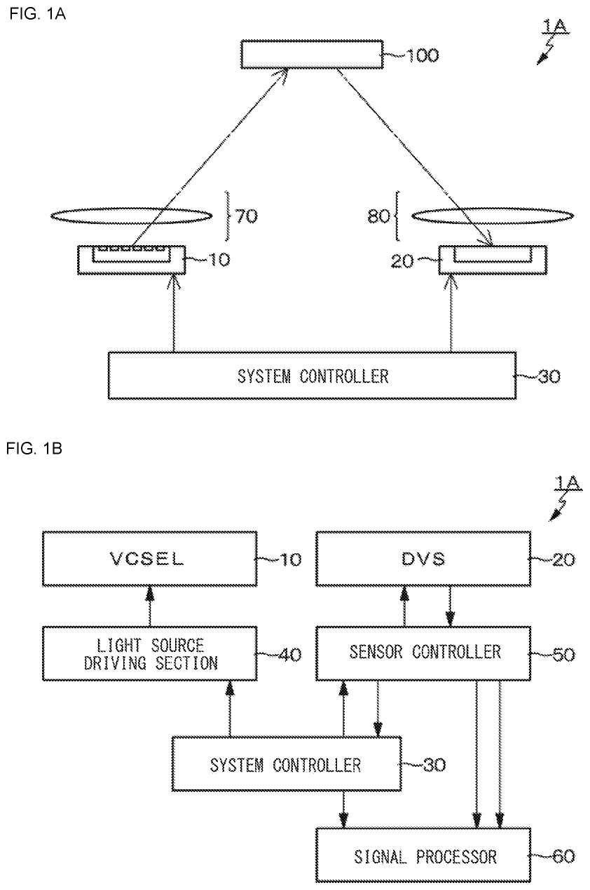

FIG. 1A is a schematic diagram illustrating an example of a configuration of the face authentication system according to the first embodiment of the present disclosure, and FIG. 1B is a block diagram of an example of a circuit configuration.

The face authentication system 1A according to first embodiment uses, as a surface-emitting light source, a surface emitting semiconductor laser, e.g., a vertical cavity surface emitting laser (VCSEL: Vertical Cavity Surface Emitting Laser) 10, and uses, as a light receiving section, an event detection sensor 20 called a DVS (Dynamic Vision Sensor).

The vertical cavity surface emitting laser 10 enables control of light emission/non-light emission in pixel units, and projects, for example, light having a predetermined pattern onto a subject 100. The event detection sensor 20 has IR (infrared) sensitivity, and receives light reflected by the subject 100, and detects, as an event, that a change in luminance of a pixel exceeds a predetermined threshold.

The face authentication system 1A according to the first embodiment includes, in addition to the vertical cavity surface emitting laser (VCSEL) 10 and the event detection sensor (DVS) 20, a system controller 30, a light source driving section 40, a sensor controller 50, a signal processor 60, a light source-side optical system 70, and a camera-side optical system 80. The vertical cavity surface emitting laser 10 and the event detection sensor 20 are described in detail later.

The system controller 30 includes, for example, a processor (CPU), and drives the vertical cavity surface emitting laser 10 through the light source driving section 40, and drives the event detection sensor 20 through the sensor controller 50.

The system controller 30 preferably controls driving of the vertical cavity surface emitting laser 10 and the event detection sensor 20 in synchronization with each other. Controlling the vertical cavity surface emitting laser 10 and the event detection sensor 20 in synchronization with each other makes it possible to prevent event information resulting from movement of a subject from being mixed with other event information and outputted. Examples of event information other than the event information resulting from the movement of the subject may include event information resulting from a change in a pattern to be projected onto the subject and background light.

### [Vertical Cavity Surface Emitting Laser (VCSEL)]

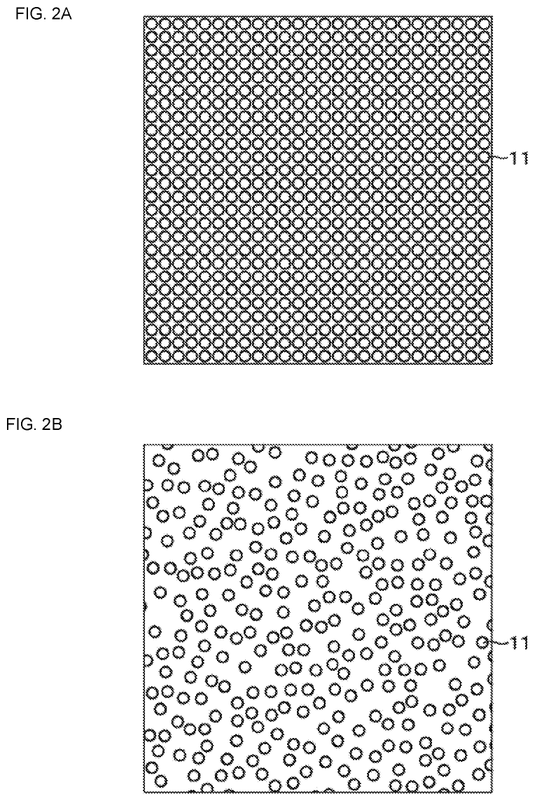

Description is given of arrangement of point light sources (dots) 11 of the vertical cavity surface emitting laser 10. The face authentication system 1A according to the first embodiment employs, for arrangement of the point light sources 11 of the vertical cavity surface emitting laser 10, a so-called array dot arrangement in which, as illustrated in FIG. 2B, the point light sources 11 are two-dimensionally arranged in an array form (matrix form) with a constant pitch.

In the face authentication system 1A according to the first embodiment including a combination of the vertical cavity surface emitting laser 10 and the event detection sensor 20, from which one of the point light sources 11 the image has been projected is easily identifiable by sequentially turning on the point light sources 11 of the vertical cavity surface emitting laser 10 and referring a time stamp of an event recorded by the event detection sensor 20, that is, time information (temporal information) indicating a relative time at which the event occurred.

In addition, in a case of the array dot arrangement, as illustrated in FIG. 2B, it is possible to increase the number of the point light sources 11 more than that in the case of a so-called random dot arrangement that includes the point light sources 11 arranged in a specific arrangement with no repetition, and has a feature in a spatial direction; therefore, there is an advantage that it is possible to increase resolution of a distance image that is determined by the number of the point light sources 11. Here, the “distance image” refers to an image for acquiring distance information to the subject. For information, in a case of the random dot arrangement, it is difficult to increase the number of the point light sources 11 while maintaining the specificity of the arrangement pattern of the point light sources 11; therefore, it is not possible to increase resolution of the distance image that is determined by the number of the point light sources 11.

The vertical cavity surface emitting laser 10 having the array dot arrangement is a surface-emitting light source that enables control of light emission/non-light emission in pixel units under control by the system controller 30. This makes it possible for the vertical cavity surface emitting laser 10 not only to entirely irradiate a subject (distance measurement object) with light, but also to partially irradiate the subject with light having a desired pattern by dot irradiation in pixel units, line irradiation in pixel column units, and the like. Performing not entire irradiation but partial irradiation in accordance with the size or the like of the subject makes it possible to reduce power consumption of the vertical cavity surface emitting laser 10.

For information, in the structured light scheme, a subject (distance measurement object) is irradiated with light at different angles from a plurality of point light sources 11, and reflected light from the subject is read out, which makes it possible to recognize the shape of the subject.

### [Event Detection Sensor (DVS)]

Next, description is given of the event detection sensor 20.

### Configuration Example of Event Detection Sensor

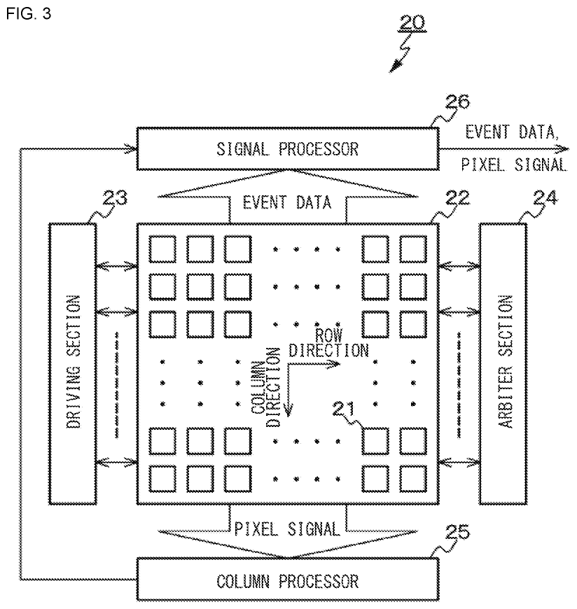

FIG. 3 is a block diagram illustrating an example of a configuration of the event detection sensor 20 in the face authentication system 1A according to the first embodiment of the present disclosure having the configuration described above.

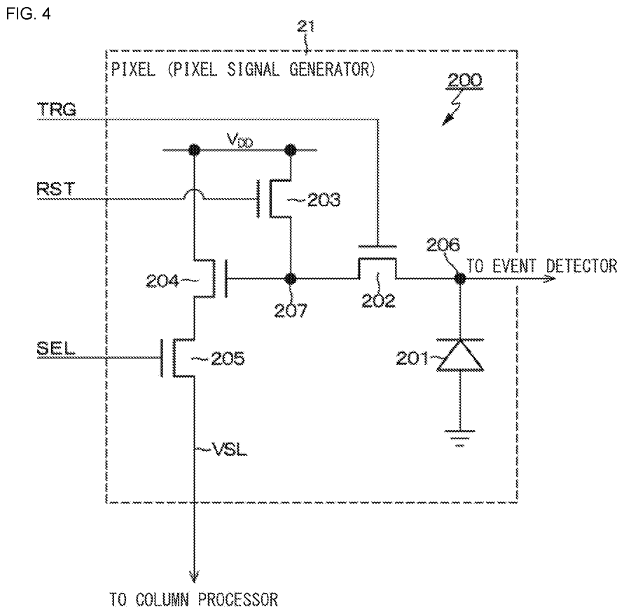

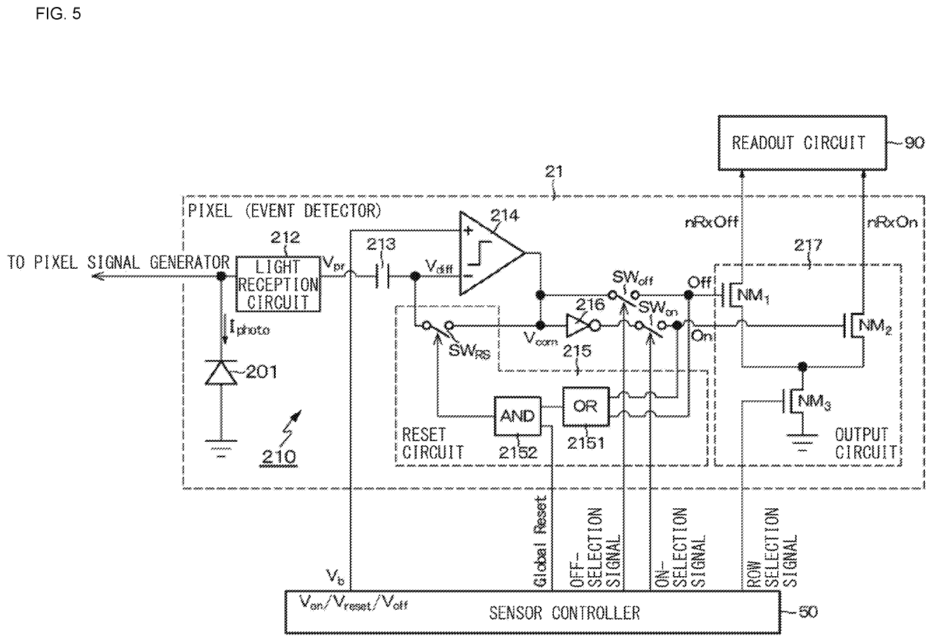

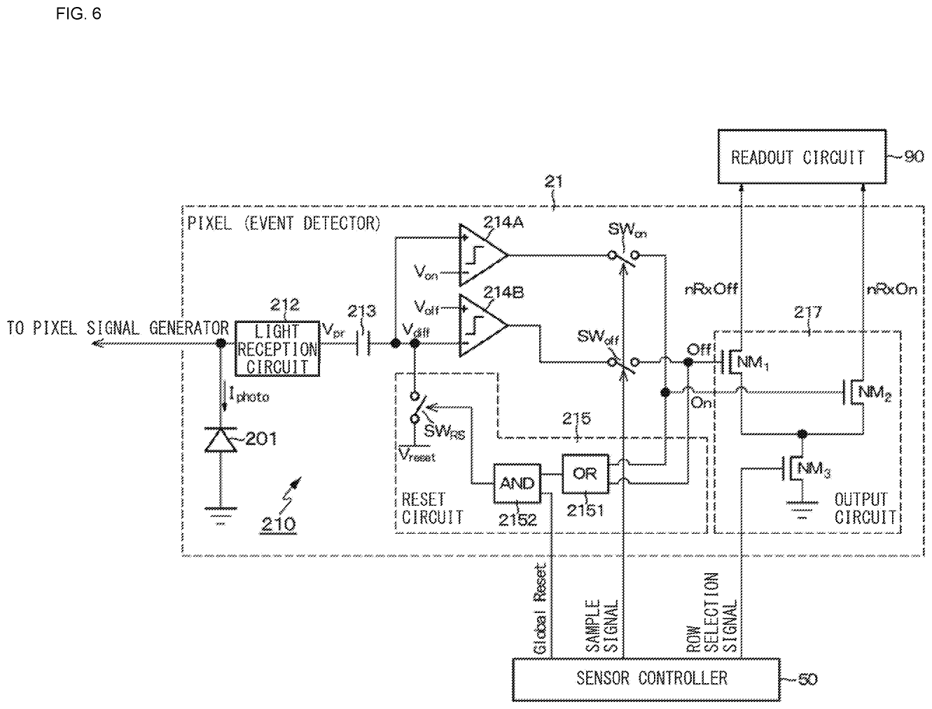

The event detection sensor 20 according to this example includes a pixel array section 22 including a plurality of pixels 21 that are two-dimensionally arranged in a matrix form (array form). The plurality of pixels 21 each includes a pixel signal generator 200 (see FIG. 4) that generates, as a pixel signal, an analog signal of a gray-scale voltage corresponding to a photocurrent as an electric signal generated by photoelectric conversion. In addition, the plurality of pixels 11 each includes an event detector 210 (see FIGS. 5 and 6) that detects the presence or absence of an event on the basis of whether or not a change exceeding a predetermined threshold has occurred in a photocurrent corresponding to luminance of entering light. In other words, the event detector 210 detects, as an event, that a change in luminance exceeds the predetermined threshold.

The event detection sensor 20 includes, in addition to the pixel array section 22, a driving section 23, an arbiter section (arbitration section) 24, a column processor 25, and a signal processor 26 as peripheral circuit sections for the pixel array section 22.

Upon detection of an event in the event detector 210, the plurality of pixels 21 each outputs, to the arbiter section 24, a request for output of event data indicating the occurrence of the event. Then, in a case where a response indicating approval for output of the event data is received from the arbiter section 24, the plurality of pixels 21 each outputs the event data to the driving section 23 and the signal processor 26. In addition, the pixel 21 that has detected the event outputs an analog pixel signal generated by photoelectric conversion to the column processor 25.

The driving section 23 drives each pixel 21 in the pixel array section 12. For example, the driving section 23 drives the pixel 21 that has detected the event and outputted the event data, and causes the analog pixel signal of that pixel 21 to be outputted to the column processor 25.

The arbiter section 24 arbitrates a request for output of event data supplied from each of the plurality of pixels 21 and transmits, to each of the pixels 21, a response based on an arbitration result (approval/disapproval for output of the event data) and a reset signal for resetting event detection.

The column processor 25 includes, for example, an analog-to-digital conversion section including an assembly of analog-to-digital converters provided for each pixel column of the pixel array section 22. Examples of the analog-to-digital converter may include a single-slope analog-to-digital converter, a successive comparison analog-to-digital converter, a delta-sigma modulation (ΔΣ modulation) analog-to-digital converter, and the like.

In the column processor 25, processing is performed for each pixel column of the pixel array section 22 to convert the analog pixel signals outputted from the pixels 21 in the column into digital signals. It is also possible for the column processor 25 to perform CDS (Correlated Double Sampling) processing on the digitized pixel signals.

The signal processor 26 executes predetermined signal processing on the digitized pixel signals supplied from the column processor 25 and the event data outputted from the pixel array section 22, and outputs the event data and the pixel signals having undergone the signal processing.

As described above, a change in the photocurrent generated in the pixel 21 may be regarded as a change in light amount (change in luminance) of light entering the pixel 21. Therefore, an event can also be said to be a change in light amount in the pixel 21 exceeding a predetermined threshold. The event data indicating the occurrence of an event includes at least position information, such as coordinates, indicating the position of the pixel 21 where the change in light amount, as an event, has occurred. The event data may include a polarity of the change in light amount, in addition to the position information.

Regarding the sequence of event data outputted from the pixels 21 at timings when events occurred, the event data can be said to implicitly include time information indicating a relative time at which the event occurred, as long as an interval between pieces of event data remains in the same state as when the events occurred.

However, the time information implicitly included in the event data is lost if the interval between the pieces of event data no longer remains in the same state as when the events occurred, due to a reason such as recordation of the event data in a memory. To cope with this, the signal processor 26 adds time information, such as a time stamp, indicating a relative time at which the event occurred, to the event data before the interval between pieces of event data no longer remains in the same state as when the events occurred.

### Circuit Configuration Example of Pixel

Next, description is given of a specific circuit configuration example of the pixel 21. The pixel 21 includes the pixel signal generator 200, illustrated in FIG. 4, that generates, as a pixel signal, an analog signal of a gray-scale voltage corresponding to a photocurrent as an electric signal generated by photoelectric conversion, and the event detector 210, illustrated in FIGS. 5 and 6, that detects, as an event, that a change in luminance exceeds a predetermined threshold.

The events include, for example, an on-event indicating that the amount of change of the photocurrent exceeds an upper threshold and an off-event indicating that the amount of change falls below a lower threshold. In addition, the event data (event information) indicating the occurrence of the event includes one bit representing a result of detection of the on-event and one bit representing a result of detection of the off-event. It is to be noted that the pixel 21 may also be configured to have a function of detecting only the on-event, or may also be configured to have a function of detecting only the off-event.

The following description is given of specific circuit configurations of the pixel signal generator 200 and the event detector 210.

### <<Pixel Signal Generator>>

FIG. 4 is a circuit diagram illustrating an example of the circuit configuration of the pixel signal generator 200 in the pixel 21. The pixel signal generator 200 has a circuit configuration including a light receiving element 201, a transfer transistor 202, a reset transistor 203, an amplification transistor 204, and a selection transistor 205.

In this circuit example, as four transistors including the transfer transistor 202, the reset transistor 203, the amplification transistor 204, and the selection transistor 205, for example, N-channel MOS field effect transistors (Field Effect Transistor: FET) are used. However, a combination of electrical conductivity types of the four transistors 202 to 205 exemplified here is only an example, and the combination of combination of electrical conductivity types of the four transistors 202 to 205 is not limited thereto.

The light receiving element 201 includes, for example, a photodiode, and has an anode electrode coupled to a low potential-side power supply (e.g., a ground), and a cathode electrode coupled to a coupling node 206. The light receiving element 201 photoelectrically converts received light into a photocurrent (photoelectric charge) having a charge amount corresponding to the light amount. An input end of the event detector 210 to be described later is coupled to the coupling node 206.

The transfer transistor 202 is coupled between the coupling node 206 and a gate electrode of the amplification transistor 204. Here, a node to which one electrode (source electrode/drain electrode) of the transfer transistor 202 and the gate electrode of the amplification transistor 204 are coupled is a floating diffusion (floating diffusion region/impurity diffusion region) 207. The floating diffusion 207 is an electric charge-to-voltage conversion section that converts electric charge into a voltage.

A transfer signal TRG that is in an active state at a high level (e.g., a V_{DD} level) is supplied from the driving section 23 (see FIG. 3) to a gate electrode of the transfer transistor 202. The transfer transistor 202 is brought into conduction in response to the transfer signal TRG to transfer, to the floating diffusion 207, the photocurrent generated by the photoelectric conversion performed in the light receiving element 201.

The reset transistor 203 is coupled between a node of the high potential-side power supply voltage V_{DD} and the floating diffusion 207. A reset signal RST that is in an active state at a high level is supplied from the driving section 23 to a gate electrode of the reset transistor 203. The reset transistor 203 is brought into conduction in response to the reset signal RST, and resets the floating diffusion 207 by sweeping out electric charge of the floating diffusion 207 to the node of the power supply voltage V_{DD}.

The amplification transistor 204 has the gate electrode coupled to the floating diffusion 207 and a drain electrode coupled to the node of the power supply voltage V_{DD}. The amplification transistor 204 serves as an input section of a source follower that reads out a signal acquired by photoelectric conversion in the light receiving element 201. That is, the amplification transistor 204 has a source electrode coupled to a vertical signal line VSL through the selection transistor 205. Thus, the amplification transistor 204 and a current source (not illustrated) coupled to one end of the vertical signal line VSL constitute a source follower that converts the voltage of the floating diffusion 207 into a potential of the vertical signal line VSL.

The selection transistor 205 has a drain electrode coupled to the source electrode of the amplification transistor 204, and a source electrode coupled to the vertical signal line VSL. A selection signal SEL that is in an active state at a high level is supplied from the driving section 23 to a gate electrode of the selection transistor 205. The selection transistor 205 is brought into conduction in response to the selection signal SEL, and thereby brings the pixel 21 into a selected state to allow the signal outputted from the amplification transistor 204 to be transferred to the vertical signal line VSL.

As described above, the transfer transistor 202 is brought into conduction in response to the transfer signal TRG to transfer, to the floating diffusion 207, a photocurrent resulting from photoelectric conversion in the light receiving element 201, which makes it possible for the pixel signal generator 200 to generate, as a pixel signal, an analog signal of a gray-scale voltage corresponding to the photocurrent.

Next, description is given of a specific circuit configuration of the event detector 210.

### Circuit Configuration Example 1 of Event Detector

A circuit configuration example 1 of the event detector 210 is an example in which one comparator is used to perform detection of the on-event and detection of the off-event in a time division manner. FIG. 5 illustrates an example of a circuit configuration of the circuit configuration example 1 of the event detector 210.

The circuit configuration example 1 of the event detector 210 is a circuit configuration including the light receiving element 201, a light reception circuit 212, a memory capacitor 213, a comparator 214, a reset circuit 215, an inverter 216, and an output circuit 217. The pixel 21 performs detection of the on-event and the off-event under control by the sensor controller 50.

The light receiving element 201 has a first electrode (anode electrode) coupled to an input end of the light reception circuit 212, and a second electrode (cathode electrode) coupled to a ground node that is a reference potential node, and photoelectrically converts entering light to generate electric charge having a charge amount corresponding to light intensity (light amount). In addition, the light receiving element 201 converts the generated electric charge into a photocurrent Iₚₕₒₜₒ.

The light reception circuit 212 converts the photocurrent Iₚₕₒₜₒ corresponding to intensity (light amount) of light detected by the light receiving element 201 into a photocurrent voltage Vₚᵣ. Here, the light receiving element 201 is used in a region in which a relationship of the voltage Vₚᵣ with intensity of light is a logarithmic relationship. Accordingly, the light reception circuit 212 converts the photocurrent Iₚₕₒₜₒ corresponding to intensity of light with which a light reception surface of the light receiving element 201 is irradiated, into the voltage Vₚᵣ that is a logarithmic function. However, the relationship between the photocurrent Iₚₕₒₜₒ and the voltage Vₚᵣ is not limited to the logarithmic relationship.

After the voltage Vₚᵣ corresponding to the photocurrent Iₚₕₒₜₒ outputted from the light reception circuit 212 passes through the memory capacitor 213, the voltage Vₚᵣ becomes, as a voltage V_{diff}, an inverted (−) input that is a first input of the comparator 214. The comparator 214 generally includes differential pair transistors. The comparator 214 receives a threshold voltage V_{b} supplied from the sensor controller 50 as a non-inverted (+) input, and performs detection of the on-event and detection of the off-event in a time division manner. In addition, after detection of the on-event/the off-event, the pixel 21 is reset by the reset circuit 215.

The sensor controller 50 outputs, as the threshold voltage V_{b}, a voltage Vₒₙ at a stage at which the on-event is detected, a voltage V_{off} at a stage at which the off-event is detected, and a voltage Vᵣₑₛₑₜ at a stage at which reset is performed, in a time division manner. The voltage Vᵣₑₛₑₜ is set to a value between the voltage Vₒₙ and the voltage V_{off}, and is preferably set to an intermediate value between the voltage Vₒₙ and the voltage V_{off}. Here, the meaning of the “intermediate value” includes a substantially intermediate value in addition to an exact intermediate value, and the presence of various variations in design or manufacturing is allowable.

In addition, the sensor controller 50 outputs an On-selection signal to the pixel 21 at the stage at which the on-event is detected, outputs an Off-selection signal at the stage at which the off-event is detected, and a global reset signal at the stage at which reset is performed. The On-selection signal is supplied to a selection switch SWₒₙ provided between the inverter 216 and the output circuit 217 as a control signal for the selection switch SWₒₙ. The Off-selection switch is supplied to a selection switch SW_{off} provided between the comparator 214 and the output circuit 217 as a control signal for the selection switch SW_{off}.

The comparator 214 compares the voltage Vₒₙ and the voltage V_{diff} with each other, and when the voltage V_{diff} exceeds the voltage Vₒₙ, the comparator 214 outputs, as a comparison result, on-event information On indicating that the amount of change of the photocurrent Iₚₕₒₜₒ exceeds the upper threshold. The on-event information On is inverted by the inverter 216, and then supplied to the output circuit 217 through the selection switch SWₒₙ.

The comparator 214 compares the voltage V_{off} and the voltage V_{diff} with each other, and when the voltage V_{diff} falls below the voltage V_{off}, the comparator 214 outputs, as a comparison result, off-event information Off indicating that the amount of change of the photocurrent Iₚₕₒₜₒ falls below the lower threshold. The off-event information Off is supplied to the output circuit 217 through the selection switch SW_{off}.

The reset circuit 215 has a configuration including a reset switch SW_{RS}, a 2-input OR circuit 2151, and a 2-input AND circuit 2152. The reset switch SW_{RS} is coupled between an inverted (−) input terminal and an output terminal of the comparator 214, and establishes a short circuit between the inverted input terminal and the output terminal by being turned to an on (closed) state.

The OR circuit 2151 receives the on-event information On supplied through the selection switch SWₒₙ and the off-event information Off supplied through the selection switch SW_{off} as two inputs. The AND circuit 2152 receives an output signal of the OR circuit 2151 as one input, and a global reset signal supplied from the sensor controller 50 as another input, and turns the reset switch SW_{RS} to an on (closed) state when one of the on-event information On and the off-event information Off is detected and the global reset signal is in an active state.

Thus, turning the output signal of the AND circuit 2152 to the active state causes the reset switch SW_{RS} to establish a short circuit between the inverted input terminal and the output terminal of the comparator 214 to perform global resetting of the pixel 21. Thus, a reset operation is performed only on the pixel 21 from which an event is detected.

The output circuit 217 has a configuration including an off-event output transistor NM₁, an on-event output transistor NM₂, and a current source transistor NM₃. The off-event output transistor NM₁ includes a memory (not illustrated) for holding the off-event information Off in a gate section thereof. The memory includes a gate parasitic capacitance of the off-event output transistor NM₁.

As with the off-event output transistor NM₁, the on-event output transistor NM₂ includes a memory (not illustrated) for holding the on-event information On in a gate section thereof. The memory includes a gate parasitic capacitance of the on-event output transistor NM₂.

At a readout stage, the off-event information Off held by the memory of the off-event output transistor NM₁ and the on-event information On held by the memory of the on-event output transistor NM₂ are transferred to a readout circuit 90 for each pixel row of the pixel array section 22 through an output line nR×Off and an output line nR×On by supplying a row selection signal from the sensor controller 50 to a gate electrode of the current source transistor NM₃. The readout circuit 90 is, for example, a circuit provided in the signal processor 26 (see FIG. 3).

As described above, the circuit configuration example 1 of the event detector 210 in the pixel 21 is a circuit configuration in which one comparator 214 is used to perform detection of the on-event and the detection of the off-event in a time division manner under control by the sensor controller 50.

### Circuit Configuration Example 2 of Event Detector

A circuit configuration example 2 of the event detector 210 is an example in which two comparators are used to perform detection of the on-event and detection of the off-event in parallel (simultaneously). FIG. 6 illustrates an example of a circuit configuration of the circuit configuration example 2 of the event detector 210.

As illustrated in FIG. 6, the circuit configuration example 2 of the event detector 210 is a configuration including a comparator 214A for detecting the on-event and a comparator 214B for detecting the off-event. Performing event detection with use of two comparators 214A and 214B in such a manner makes it possible to execute an on-event detection operation and an off-event detection operation simultaneously. As a result, it is possible to achieve a faster operation for the on-event detection operation and the off-event detection operation.

The comparator 214A for on-event detection generally includes differential pair transistors. The comparator 214A receives the voltage V_{diff} corresponding to the photocurrent Iₚₕₒₜₒ as a non-inverted (+) input that is a first input, and the voltage Vₒₙ serving as the threshold voltage V_{b} as an inverted (−) input that is a second input. The comparator 214a outputs the on-event information On as a result of comparison between these voltages. The comparator 214B for off-event detection also generally includes differential pair transistors. The comparator 214B receives the voltage V_{diff} corresponding to the photocurrent Iₚₕₒₜₒ as an inverted input that is a first input, and the voltage V_{off} serving as the threshold voltage V_{b} as a non-inverted input that is a second input. The comparator 214B outputs the off-event information Off as a result of comparison between these voltages.

The selection switch SWₒₙ is coupled between an output terminal of the comparator 214A and a gate electrode of the on-event output transistor NM₂ of the output circuit 217. The selection switch SW_{off} is coupled between an output terminal of the comparator 214B and a gate electrode of the off-event output transistor NM₁ of the output circuit 217. On (closed)/off (open) control of the selection switch SWₒₙ and the selection switch SW_{off} is performed by a sample signal outputted from the sensor controller 50.

The on-event information On as a comparison result of the comparator 214A is held by the memory of the gate section of the on-event output transistor NM₂ through the selection switch SWₒₙ. The memory for holding the on-event information On includes a gate parasitic capacitance of the on-event output transistor NM₂. The on-event Off as a comparison result of the comparator 214B is held by the memory of the gate section of the off-event output transistor NM₁ through the selection switch SW_{off}. The memory for holding the on-event Off includes a gate parasitic capacitance of the off-event output transistor NM₁.

The on-event information On held by the memory of the on-event output transistor NM₂ and the off-event information Off held by the memory of the off-event output transistor NM₁ are transferred to the readout circuit 90 for each pixel row of the pixel array section 22 through the output line nR×On and the output line nR×Off by supplying the row selection signal from the sensor controller 50 to the gate electrode of the current source transistor NM₃.

As described above, the circuit configuration example 2 of the event detector 210 in the pixel 21 is a circuit configuration in which two comparators 214A and 214B are used to perform detection of the on-event and detection of the off-event in parallel (simultaneously) under control by the sensor controller 50.

### [Chip Structure]

Next, description is given of chip structures of the vertical cavity surface emitting laser (VCSEL) 10 and the event detection sensor (DVS) 20.

### Example of Vertical Cavity Surface Emitting Laser

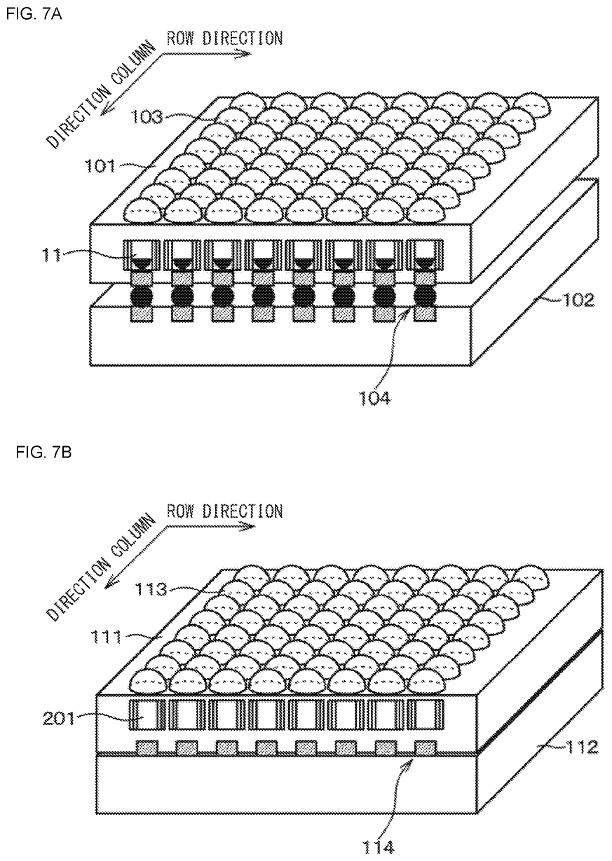

FIG. 7A illustrates an outline of the chip structure of the vertical cavity surface emitting laser 10. It is to be noted that for simplification of the drawing, FIG. 7A illustrates an array arrangement of 8 horizontal×8 vertical (64 in total) point light sources 11.

The vertical cavity surface emitting laser 10 has a chip structure in which a first semiconductor substrate 101 and a second semiconductor substrate 102 are stacked. In the first semiconductor substrate 101, the point light sources 11 each including a laser light source are formed in a two-dimensional matrix (array) arrangement, and lenses 103 are provided corresponding to the respective point light sources 11 on a light emission surface. In the second semiconductor substrate 102, the light source driving section 40 and the like illustrated in FIG. 1B are formed. In addition, the first semiconductor substrate 101 and the second semiconductor substrate 102 are electrically coupled to each other through a junction 104 including bump bonding or the like.

### Example of Event Detection Sensor

FIG. 7B illustrates an outline of the chip structure of the event detection sensor 20. It is to be noted that for simplification of the drawing, FIG. 7B illustrates an array arrangement of 8 horizontal×8 vertical (64 in total) light receiving elements 201.

The event detection sensor 20 has a chip structure in which a first semiconductor substrate 111 and a second semiconductor substrate 112 are stacked. In the first semiconductor substrate 111, the light receiving elements 201 (e.g., photodiodes) are formed in a two-dimensional matrix arrangement, and lenses 113 are provided corresponding to the respective light receiving elements 201 on a light reception surface. In the second semiconductor substrate 112, a readout circuit including the pixel signal generator 200 and the event detector 210, and the like are formed. In addition, the first semiconductor substrate 111 and the second semiconductor substrate 112 are electrically coupled to each other through a junction 114 including Cu—Cu bonding or the like.

### Process Example of Face Authentication

In the face authentication system 1 including the vertical cavity surface emitting laser (VCSEL) 10 and the event detection sensor (DVS) 20 having the configurations described above, the event data and the pixel signal are outputted from the event detection sensor 20. That is, when detecting, by an action of the event detector 210, as an event, that a change in luminance of the pixel 21 that photoelectrically converts entering light exceeds a predetermined threshold, the event detection sensor 20 outputs event data including a time stamp (time information) indicating a relative time at which the event occurred.

In addition, the event detection sensor 20 outputs, as a pixel signal, an analog signal of a gray-scale voltage corresponding to an electric signal generated by photoelectric conversion by an action of the pixel signal generator 200. That is, the event detection sensor 20 including the pixel signal generator 200 is a sensor (imaging element) that reads out the analog signal of the gray-scale voltage as a pixel signal, that is, enables gray-scale readout. This gray-scale readout makes it possible for the signal processor 26 to acquire a gray scale from the pixel signal generated by the pixel signal generator 200.

The event data and the pixel signal outputted from the event detection sensor 20 are supplied to the signal processor 60. The signal processor 60 is able to perform a face (object) position detection process by distance measurement based on the event data supplied from the event detection sensor 20 under control by the system controller 30. In addition, the signal processor 60 is able to perform face (object) shape recognition process on the basis of the pixel signal supplied by gray-scale readout of the event detection sensor 20 under control by the system controller 30. Furthermore, the signal processor 60 is able to perform face authentication with use of a known face authentication technology under control by the system controller 30.

As described above, the face authentication system 1A according to the first embodiment has a configuration using the vertical cavity surface emitting laser 10 that enables control of light emission/non-light emission in pixel units, and the event detection sensor 20 that has IR sensitivity and enables gray-scale readout. According to the face authentication system 1A according to the first embodiment, it is possible to constitute a system that not only acquires a three-dimensional shape but also enables face authentication with a small number of components of the vertical cavity surface emitting laser 10 and the event detection sensor 20.

Next, description is given of a specific process example for face authentication to be executed in the signal processor 60 under control by the system controller 30.

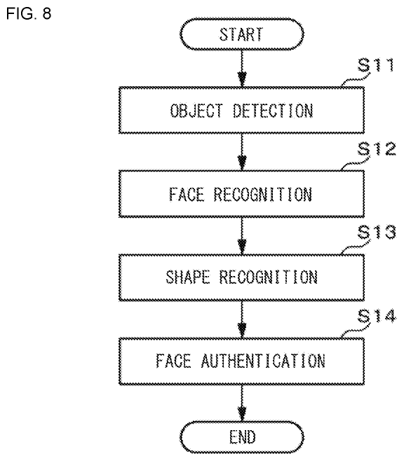

FIG. 8 is a flowchart illustrating a face authentication process example in the face authentication system 1A according to the first embodiment. This process is executed in the signal processor 60 under control by a processor included in the system controller 30 in a case of a configuration in which a function of the system controller 30 is implemented by the processor.

The processor included in the system controller 30 (hereinafter simply referred to as “processor”) uses the vertical cavity surface emitting laser 10 and the event detection sensor 20 to perform object detection at a specific position, or face detection in this example (step S11).

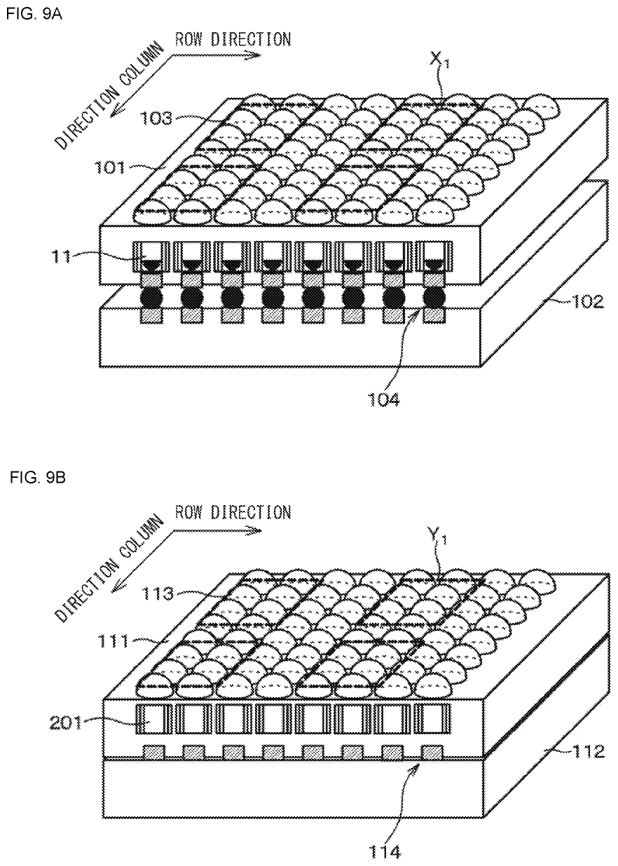

In the object detection process, a face is present in a limited region within a shooting range; therefore, as illustrated in FIG. 9A, in the vertical cavity surface emitting laser 10, only the point light sources 11 in a specific region (region surrounded by a broken line X₁) of a pixel array are operated. In contrast to this, as illustrated in FIG. 9B, also in the event detection sensor 20, only pixels 21 including the light receiving elements 201 in a specific region (region surrounded by a broken line Y₁) of the pixel array are operated. Then, in the object detection process, the event detection sensor 20 performs an operation using the event data outputted from the event detector 210 illustrated in FIG. 5 or FIG. 6.

Partially operating the vertical cavity surface emitting laser 10 and the event detection sensor 20 makes it possible to perform distance measurement upon object detection with low power consumption. It is to be noted that the operation of the event detection sensor 20 with low power consumption is achievable by on/off control of a power supply for each of the pixels 21.

The object detection with use of the vertical cavity surface emitting laser 10 and the event detection sensor 20 is achievable by using, for example, a known triangulation system in which a distance to an object (subject/distance measurement object) is measured with use of a triangulation method. However, in this example, a technique is adopted of partially operating the vertical cavity surface emitting laser 10 and the event detection sensor 20, resulting in rough distance measurement as compared with a case where they are entirely operated.

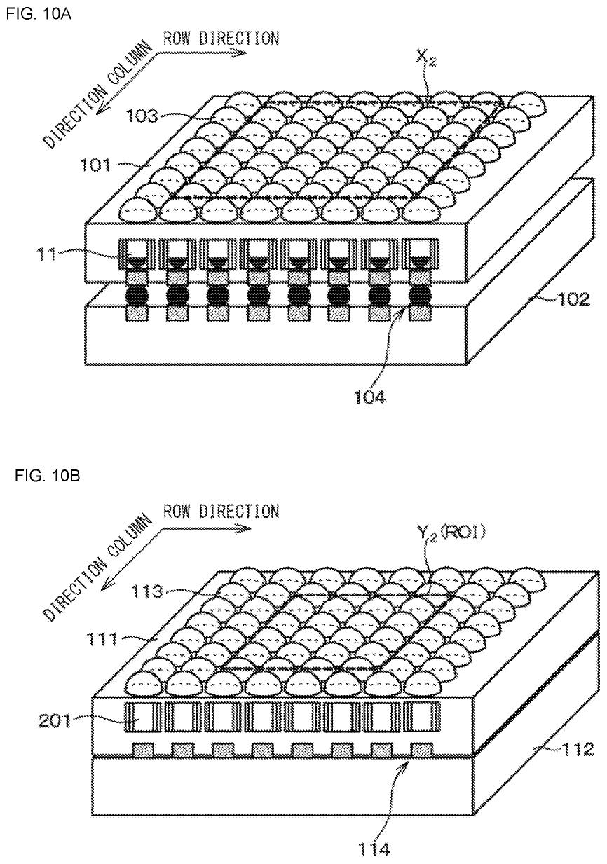

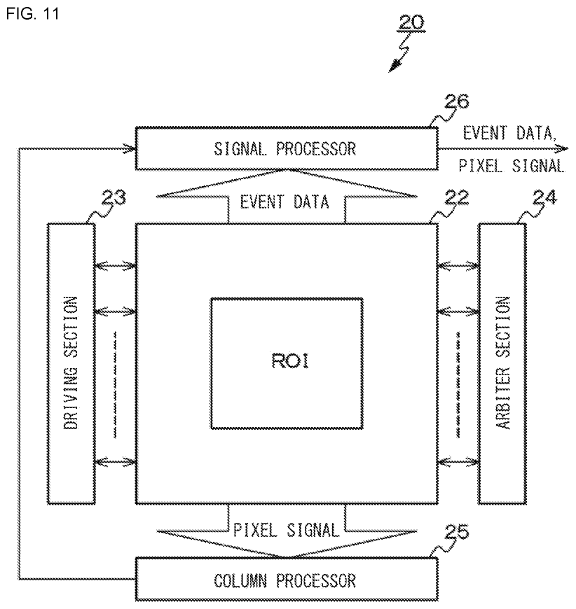

Next, the processor performs a recognition process of a feature of a face detected by object detection, e.g., a recognition process such as whether or not eyes are open (step S12). In this face recognition process, in the vertical cavity surface emitting laser 10, partial irradiation is not performed, and the point light sources 11 in a wide-angle region (region surrounded by a broken line X₂) are operated as illustrated in FIG. 10A. In contrast, in the event detection sensor 20, as illustrated in FIG. 10B, the pixels 21 including the light receiving elements 201 in a specific region of interest, that is, a ROI (Region Of Interest) region (region surrounded by a broken line Y₂) are operated. FIG. 11 illustrates the ROI region upon face recognition in the pixel array section 22 of the event detection sensor 20. Then, in the face recognition process, in the event detection sensor 20, a gray-scale readout operation using the pixel signal generator 200 illustrated in FIG. 4 is performed. This gray-scale readout operation makes it possible to acquire a high-resolution image.

As described above, in the face recognition process in the step S12, a high-resolution image of the face detected by the object detection is acquired by the wide-angle irradiation by the vertical cavity surface emitting laser 10 and the gray-scale readout operation by the event detection sensor 20. Then, an eye state, a feature point of the face, and the like are extracted for face authentication on the basis of the high-resolution image. For information, authentication is not possible in a state in which eyes are closed such as during sleep.

For this face recognition, it is possible to use a pattern recognition technology by machine learning such as a neural network, e.g., a technology in which a recognition process is performed by comparing a feature point of a face supplied as teacher data with a feature point of a captured face image.

Next, the processor performs shape recognition of the recognized face (step S13). In this shape recognition process, the shape recognition of the face is performed by a distance measurement system using the structured light scheme. Specifically, in the vertical cavity surface emitting laser 10 that enables control of light emission/non-light emission in pixel units, the recognized face is irradiated with light having a time-series pattern by dot irradiation, line irradiation, or the like.

In contrast, in the event detection sensor 20, the event data outputted from the event detector 210 illustrated in FIG. 5 or FIG. 6 is used. The event data includes a time stamp that is time information indicating a relative time at which the event occurred. It is possible to specify a occurrence point of the event on the basis of the time stamp (time information).

As described above, in the shape recognition process in the step S13, shape recognition of the face is performed by highly accurate matching in a spatial direction in a time series by the vertical cavity surface emitting laser 10 that enables control of light emission/non-light emission in pixel units and the event detection sensor 20 that reads out the occurrence point of the event from the time stamp (time information).

Finally, the processor performs authentication of the face of which the shape has been recognized, with use of a known face authentication technology (step S14). Examples of the known face authentication technology may include a technology in which face authentication is performed by extracting a plurality of feature points of a face image of the recognized face and matching up the plurality of feature points with feature points that have been already registered.

### Modification Examples of First Embodiment

The face authentication system 1A according to the first embodiment is configured to perform object detection at a specific position, object feature recognition, and object shape recognition on the basis of the detection result of the event detection sensor 20 and the pixel signal generated by the pixel signal generator. However, a system configuration may be adopted in which a distance to an object is measured for object detection.

In addition, a system configuration may be adopted in which object detection at a specific position and object shape recognition are performed on the basis of the detection result of the event detection sensor 20 and the pixel signal generated by the pixel signal generator, or a system configuration may be adopted in which object feature recognition is performed on the basis of the detection result of the event detection sensor 20 and the pixel signal generated by the pixel signal generator.

### Face Authentication System According to Second Embodiment

The face authentication system 1A according to the first embodiment has a system configuration including a combination of a surface-emitting light source that enables control of light emission/non-light emission in pixel units and an event detection sensor that enables gray-scale readout. In contrast, a face authentication system 1B according to a second embodiment uses only an event detection sensor that enables gray-scale readout, and has a simple system configuration as compared with the face authentication system 1A according to the first embodiment.

### System Configuration Example

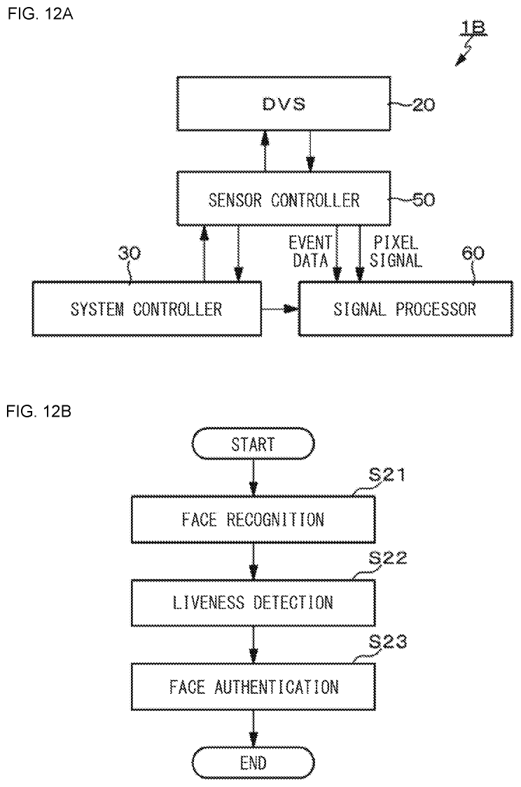

FIG. 12A is a schematic diagram illustrating an example of a configuration of the face authentication system according to the second embodiment of the present disclosure.

The face authentication system 1B according to the second embodiment uses, as a light receiving section that receives light from a subject, the event detection sensor (DVS) 20 that enables gray-scale readout, as with the face authentication system 1A according to the first embodiment. That is, the event detection sensor 20 includes the pixel signal generator 200 that generates, as a pixel signal, an analog signal of a gray-scale voltage corresponding to a photocurrent as an electric signal generated by photoelectric conversion, and the event detector 210 that detects, as an event, that a change in luminance exceeds a predetermined threshold, and is configured to enable gray-scale readout in which the analog signal of the gray-scale voltage is read out as the pixel signal.

The face authentication system 1B according to the second embodiment includes the system controller 30, the sensor controller 50, and the signal processor 60 in addition to the event detection sensor 20. The system controller 30 includes, for example, a processor, and drives the event detection sensor 20 through the sensor controller 50.

The signal processor 60 is able to perform face recognition on the basis of the pixel signal supplied by gray-scale readout of the event detection sensor 20 under control by the system controller 30. In addition, the signal processor 60 is able to perform liveness detection (e.g., blink detection) on the basis of even data supplied from the event detection sensor 20 under control by the system controller 30. Furthermore, the signal processor 60 is able to perform face authentication with use of a known face authentication technology under control by the system controller 30.

According to the face authentication system 1B according the second embodiment having the configuration described above, using the event detection sensor 20 that enables gray-scale readout makes it possible to constitute a system that not only acquires a three-dimensional shape but also enables face authentication.

### Face Authentication Process Example

Next, description is given of a specific process example for face authentication to be executed in the signal processor 60 under control by the system controller 30.

FIG. 12B is a flowchart illustrating a process example of face authentication in the face authentication system 1B according to the second embodiment. This process is executed in the signal processor 60 under control by a processor that implements a function of the system controller 30.

The processor performs a gray-scale readout operation in the event detection sensor 20, and performs recognition of a face in an image on the basis of the pixel signal outputted from the pixel signal generator 200 (step S21), and then performs liveness detection of the face, e.g., blink detection on the basis of event data outputted from the event detector 210 (step S22).

Next, the processor performs authentication of the face having undergone the liveness detection with use of a known face authentication technology (step S23). Examples of the known face authentication technology may include a technology in which face authentication is performed by extracting a plurality of feature points of a face image of the recognized face and matching up the plurality of feature points with feature points that have been already registered.

As described above, according to the face authentication system 1B according to the second embodiment, using only the event detection sensor 20 that enables gray-scale readout and detection of a change in luminance makes it possible to constitute a system that not only acquires a three-dimensional shape but also enables face authentication with a smaller number of components.

### Modification Examples

Although the technology of the present disclosure has been described with reference to preferred embodiments, the technology of the present disclosure is not limited to the embodiments. The configurations and structures of the face authentication system described in the above embodiments are illustrative, and may be appropriately modified.

### Electronic Apparatus of Present Disclosure

The face authentication system of the present disclosure described above is usable, for example, as a system to be mounted to any of various electronic apparatuses having a face authentication function. Examples of the electronic apparatuses having the face authentication function may include mobile apparatuses such as a smartphone, a tablet, and a personal computer. However, as an electronic apparatus that is able to use the face authentication system of the present disclosure is not limited to the mobile apparatuses.

### [Smartphone]

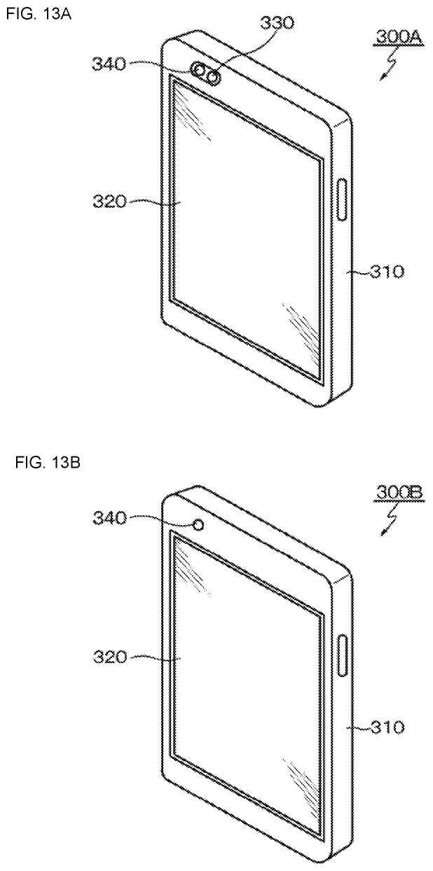

Here, a specific example of the electronic apparatus of the present disclosure that is able to use the face authentication system of the present disclosure is a smartphone. FIG. 13 illustrates an external view of the smartphone as viewed from front side. FIG. 13A is an example of a smartphone including the face authentication system according to the first embodiment, and FIG. 13B is an example of a smartphone including the face authentication system according to the second embodiment.

Each of smartphones 300A and 300B according to this specific example includes a display section 320 on front side of a housing 310. Further, the smartphone 300A including the face authentication system 1A according to the first embodiment includes a light emitting section 330 and a light receiving section 340 in an upper section on the front side of the housing 310. It is to be noted that a disposition example of the light emitting section 330 and the light receiving section 340 illustrated in FIG. 13A is only an example, and disposition of the light emitting section 330 and the light receiving section 340 is not limited thereto. The smartphone 300B including the face authentication system 1B according to the second embodiment includes only the light receiving section 340 on the upper section on the front side of the housing 310. It is to be noted that a disposition example of the light receiving section 340 illustrated in FIG. 13B is also only an example, and disposition of the light receiving section 340 is not limited thereto.

In the smartphones 300A and 300B that are examples of the mobile apparatus having the configuration described above, it is possible to use, as the light emitting section 330, the vertical cavity surface emitting laser (VCSEL) 10 in the face authentication system 1A (1B) described above, and to use, as the light receiving section 340, the event detection sensor (DVS) 20 in the face authentication system 1A (1B). That is, the smartphone 300A according to this specific example is fabricated with use of the face authentication system 1A according to the first embodiment described above, and the smartphone 300B according to this specific example is fabricated with use of the face authentication system 1B according to the second embodiment described above.

### Possible Configurations of Present Disclosure

It is to be noted that the present disclosure may also have the following configurations.

### <<A. Face Authentication System>>

### [A-1]

A face authentication system including:

a surface-emitting light source that irradiates a subject with light, and enables control of light emission/non-light emission in pixel units;

an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and

a signal processor that performs authentication of a face that is the subject on the basis of a detection result of the event detection sensor and the pixel signal generated by the pixel signal generator.

### [A-2]

The face authentication system according to [A-1], in which the surface-emitting light source includes a surface-emitting semiconductor laser.

### [A-3]

The face authentication system according to [A-2], in which the surface-emitting semiconductor laser includes a vertical cavity surface emitting laser.

### [A-4]

The face authentication system according to [A-3], in which the vertical cavity surface emitting laser enables dot irradiation in pixel units or line irradiation in pixel column units.

### [A-5]

The face authentication system according to any one of [A-2] to [A-4], in which the event detection sensor has infrared sensitivity.

### [A-6]

The face authentication system according to any one of [A-1] to [A-5], in which the surface-emitting light source and the event detection sensor are operable only in a specific region of a pixel array.

### [A-7]

The face authentication system according to any one of [A-1] to [A-6], in which the signal processor determines a distance to the subject with use of the detection result of the event detector.

### [A-8]

The face authentication system according to any one of [A-1] to [A-7], in which the signal processor acquires a gray scale from the pixel signal generated from the pixel signal generator.

### [A-9]

The face authentication system according to [A-8], in which the signal processor performs object detection at a specific position and object shape recognition on the basis of the detection result of the event detection sensor and the pixel signal generated by the pixel signal generator.

### [A-10]

The face authentication system according to [A-9], in which the signal processor performs object feature recognition on the basis of the detection result of the event detection sensor and the pixel signal generated by the pixel signal generator. <<B. Electronic Apparatus>>

### [B-1]

An electronic apparatus provided with a face authentication system, the face authentication system including:

a surface-emitting light source that irradiates a subject with light, and enables control of light emission/non-light emission in pixel units;

an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and

a signal processor that performs authentication of a face that is the subject on the basis of a detection result of the event detection sensor and the pixel signal generated by the pixel signal generator.

### [B-2]

The electronic apparatus according to [B-1], in which the surface-emitting light source includes a surface-emitting semiconductor laser.

### [B-3]

The electronic apparatus according to [B-2], in which the surface-emitting semiconductor laser includes a vertical cavity surface emitting laser.

### [B-4]

The electronic apparatus according to [B-3], in which the vertical cavity surface emitting laser enables dot irradiation in pixel units or line irradiation in pixel column units.

### [B-5]

The electronic apparatus according to any one of [B-2] to [B-4], in which the event detection sensor has infrared sensitivity.

### [B-6]

The electronic apparatus according to any one of [B-1] to [B-5], in which the surface-emitting light source and the event detection sensor are operable only in a specific region of a pixel array.

### [B-7]

The electronic apparatus according to any one of [B-1] to [B-6], in which the signal processor determines a distance to the subject with use of the detection result of the event detector.

### [B-8]

The electronic apparatus according to any one of [B-1] to [B-7], in which the signal processor acquires a gray scale from the pixel signal generated from the pixel signal generator.

### [B-9]

The electronic apparatus according to [B-8], in which the signal processor performs object detection at a specific position and object shape recognition on the basis of the detection result of the event detection sensor and the pixel signal generated by the pixel signal generator.

### [B-10]

The electronic apparatus according to [B-9], in which the signal processor performs object feature recognition on the basis of the detection result of the event detection sensor and the pixel signal generated by the pixel signal generator.

### REFERENCE SIGNS LIST

1A: face authentication system according to first embodiment
1B: face authentication system according to second embodiment
10: vertical cavity surface emitting laser (VCSEL)
11: point light source
20: event detection sensor (DVS)
21] pixel
22: pixel array section
23: driving section
24: arbiter section
25: column processor
26: signal processor
30: system controller
40: light source driving section
50: sensor controller
60: signal processor
70: light source-side optical system
80: camera-side optical system
100: subject
200: pixel signal generator
210: event detector
300A, 300B: smartphone

1. A face authentication system comprising:
a surface-emitting light source that irradiates a subject with light, and enables control of light emission/non-light emission in pixel units;
an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and
a signal processor that performs authentication of a face that is the subject on a basis of a detection result of the event detection sensor and the pixel signal generated by the pixel signal generator.

2. The face authentication system according to claim 1, wherein the surface-emitting light source comprises a surface-emitting semiconductor laser.

3. The face authentication system according to claim 2, wherein the surface-emitting semiconductor laser comprises a vertical cavity surface emitting laser.

4. The face authentication system according to claim 3, wherein the vertical cavity surface emitting laser enables dot irradiation in pixel units or line irradiation in pixel column units.

5. The face authentication system according to claim 2, wherein the event detection sensor has infrared sensitivity.

6. The face authentication system according to claim 1, wherein the surface-emitting light source and the event detection sensor are operable only in a specific region of a pixel array.

7. The face authentication system according to claim 1, wherein the signal processor determines a distance to the subject with use of the detection result of the event detector.

8. The face authentication system according to claim 1, wherein the signal processor acquires a gray scale from the pixel signal generated from the pixel signal generator.

9. The face authentication system according to claim 8, wherein the signal processor performs object detection at a specific position and object shape recognition on a basis of the detection result of the event detection sensor and the pixel signal generated by the pixel signal generator.

10. The face authentication system according to claim 9, wherein the signal processor performs object feature recognition on a basis of the detection result of the event detection sensor and the pixel signal generated by the pixel signal generator.

11. A face authentication system comprising:
an event detection sensor including an event detector that detects, as an event, that a change in luminance of a pixel that photoelectrically converts entering light from a subject exceeds a predetermined threshold, and a pixel signal generator that generates a pixel signal of a gray-scale voltage generated by photoelectric conversion; and
a signal processor that performs authentication of a face that is the subject on a basis of a detection result of the event detection sensor and the pixel signal generated by the pixel signal generator.

12. An electronic apparatus provided with a face authentication system, the face authentication system comprising:
a surface-emitting light source that irradiates a subject with light, and enables control of light emission/non-light emission in pixel units;
an event detection sensor including an event detector that detects, as an event, that a change in luminance of a pixel that photoelectrically converts entering light from the subject exceeds a predetermined threshold, and a pixel signal generator that generates a pixel signal of a gray-scale voltage generated by photoelectric conversion; and
a signal processor that performs authentication of a face that is the subject on a basis of a detection result of the event detection sensor and the pixel signal generated by the pixel signal generator.
